(19) United States
(12) Patent Application Publication
(10) Pub. No.: US 2018/0067290 A1
(43) Pub. Date: Mar. 8, 2018

(54) PRISM OPTICAL SYSTEM, PRISM OPTICAL SYSTEM-INCORPORATED IMAGE DISPLAY APPARATUS, AND PRISM OPTICAL SYSTEM-INCORPORATED IMAGING APPARATUS

(71) Applicant: OLYMPUS CORPORATION, Tokyo (JP)

(72) Inventor: Koichi TAKAHASHI, Tokyo (JP)

(73) Assignee: OLYMPUS CORPORATION, Tokyo (JP)

(21) Appl. No.: 15/806,511

(22) Filed: Nov. 8, 2017

Related U.S. Application Data
(63) Continuation of application No. PCT/JP2015/063490, filed on May 11, 2015.

(51) Int. Cl. G02B 17/08; G02F 1/1335; G02B 27/01

(52) U.S. Cl. CPC G02B 17/086; G02F 1/133553; G02B 2027/015; G02B 27/0176; G02B 27/0172

(57) ABSTRACT

A prism optical system has an optical element that includes an entrance-side reflecting surface having reflection on the most entrance-side of the optical element on an optical path, an exit-side reflecting surface having reflection on the most exit side of the optical element on the optical path, and an intermediate reflecting surface having reflection between the entrance-side reflecting surface and the exit-side reflecting surface on the optical path,
a thickness of an intermediate area including the intermediate reflecting surface in the X-Z plane is greater than a thickness of an entrance-side area including the entrance-side reflecting surface or a thickness of an exit-side area including the exit-side reflecting surface, and
the following condition (1) is satisfied:

0.5<Tn/Tc<1.0 (1)

where Tn is a thickness of the entrance-side area including the entrance-side reflecting surface, and Tc is a thickness of the intermediate area including the intermediate reflecting surface.

### CROSS-REFERENCE TO RELATED APPLICATIONS

This application is based on PCT/JP2015/063490 filed on May 11, 2015. The content of the PCT application is incorporated herein by reference.

### BACKGROUND OF THE INVENTION AND RELATED ART STATEMENT

The present invention relates to a prism optical system that uses a rotationally asymmetric surface, an image display apparatus that incorporates a prism optical system, and an imaging apparatus that incorporates a prism optical system.

A prism optical system known so far in the art is typically a prism that includes a plurality of optical surfaces, and in the form of an optical system adapted to view an image display device, light emanating from the display device enters the prism for internal reflection, and exits out of the prism, arriving at the eyeballs of a viewer where an image is viewed as an enlarged virtual image. For prior arts concerning this, for instance, there is the mention of JP(A) 2008-076429 showing a prism wherein a first-order image is formed by at least three reflecting surfaces for projection onto the eyeballs, and JP(A) 2008-076429, JP(A) 2007-094175 and JP(A) 2004-325985 teaching that a hologram element is located at a lens site of eyeglasses.

Another conventional prism optical system includes a parallelogram prism wherein light is reflected a plurality of times and guided in front of the eyeballs of a viewer for projection through an eyepiece onto the eyeballs, or a light guide and an eyepiece for projection of light onto the eyeballs (see JP(A) 2001-264681 or JP(A) 2006-003879). Besides, it is proposed to make use of a prism including a combination of mutually decentered five optical surfaces to project an image from an image display device onto the eyeballs of a viewer (see JP(A) 2012-027350).

### SUMMARY OF INVENTION

A prism optical system has

an optical element that includes at least three optical surfaces, each having an optical action, in which after subjected to at least three internal reflections, incident light exits out for formation of images, wherein

the optical element includes an entrance-side reflecting surface having reflection on the most entrance-side of the optical element on an optical path, an exit-side reflecting surface having reflection on the most exit side of the optical element on the optical path, and an intermediate reflecting surface having reflection between the entrance-side reflecting surface and the exit-side reflecting surface on the optical path,

given that a Z-axis positive direction is defined by a direction along a direction of travel of a center chief ray that passes from one point as an origin included in that dummy plane through the center of an entrance pupil and is perpendicular to a surface that forms the entrance pupil, a Y-Z plane is defined by a plane including the Z-axis and the center of an image plane, a Y-axis positive direction comes close to a direction from the origin toward the center of the image plane, an X-axis positive direction is defined by a direction that forms a right-handed orthogonal coordinate system with the Y-axis and the Z-axis,

a thickness of an intermediate area including the intermediate reflecting surface in the X-Z plane is greater than a thickness of an entrance-side area including the entrance-side reflecting surface or a thickness of an exit-side area including the exit-side reflecting surface, and

the following condition (1) is satisfied:

0.5<Tn/Tc<1.0 (1)

where Tn is a thickness of the entrance-side area including the entrance-side reflecting surface, and Tc is a thickness of the intermediate area including the intermediate reflecting surface.

A prism optical system has

an optical element that includes at least three optical surfaces, each having an optical action, in which after subjected to at least three internal reflections, incident light exits out for formation of images, wherein

the optical element includes an entrance-side reflecting surface having reflection on the most entrance side of the optical element on an optical path, an exit-side reflecting surface having reflection on the most exit side of the optical element on the optical path, and an intermediate reflecting surface having reflection between the entrance-side reflecting surface and the exit-side reflecting surface on the optical path,

given that a Z-axis positive direction is defined by a direction along a direction of travel of a center chief ray that passes from one point as an origin included in that dummy plane through the center of an entrance pupil and is perpendicular to a surface that forms the entrance pupil, a Y-Z plane is defined by a plane including the Z-axis and the center of an image plane, and a Y-axis positive direction comes close to a direction from the origin toward the center of the image plane, an X-axis positive direction is defined by a direction that forms a right-handed orthogonal coordinate system with the Y-axis and the Z-axis,

a thickness of an intermediate area including the intermediate reflecting surface in the X-Z plane is greater than a thickness of an entrance-side area including the entrance-side reflecting surface or a thickness of an exit-side area including the exit-side reflecting surface, and

the following condition (2) is satisfied:

0.3<Ts/Tc<1.0 (2)

where Ts is the thickness of the exit-side area including the exit-side reflecting surface, and Tc is a thickness of the intermediate area including the intermediate reflecting surface.

### BRIEF DESCRIPTION OF DRAWINGS

FIG. 1 is illustrative in arrangement of the prism optical system according to one embodiment.

FIG. 2 is illustrative in the X-Y section arrangement of the prism optical system according to one embodiment.

FIG. 3 is an optical path diagram in the Y-Z section for the prism optical system of Example 1 according to one embodiment.

FIG. 4 is an optical path diagram in the X-Z section for the prism optical system of Example 1 according to one embodiment.

FIG. 5 is a set of transverse aberration diagrams for the whole prism optical system of Example 1 according to one embodiment.

FIG. 6 is a set of transverse aberration diagrams for the whole prism optical system of Example 1 according to one embodiment.

FIG. 7 is an optical path diagram in the Y-Z section for the prism optical system of Example 2 according to one embodiment.

FIG. 8 is an optical path diagram in the X-Z section for the prism optical system of Example 2 according to one embodiment.

FIG. 9 is a set of transverse aberration diagrams for the whole prism optical system of Example 2 according to one embodiment.

FIG. 10 is a set of transverse aberration diagrams for the whole prism optical system of Example 2 according to one embodiment.

FIG. 11 is an optical path diagram in the Y-Z section for the prism optical system of Example 3 according to one embodiment.

FIG. 12 is an optical path diagram in the X-Z section for the prism optical system of Example 3 according to one embodiment.

FIG. 13 is a set of transverse aberration diagrams for the whole prism optical system of Example 3 according to one embodiment.

FIG. 14 is a set of transverse aberration diagrams for the whole prism optical system of Example 3 according to one embodiment.

FIG. 15 is illustrative in fundamental arrangement of an image display apparatus that incorporates a prism optical system in it.

FIG. 16 is a side view of the image display apparatus incorporating a prism optical system in it.

FIG. 17 is a side view of another example of the image display apparatus incorporating a prism optical system in it.

FIG. 18 is illustrative of a head-mounted type image display apparatus incorporating a prism optical system in it.

FIG. 19 is a front view of the head-mounted type image display apparatus incorporating a prism optical system in it.

FIG. 20 is illustrative in conception of an imaging apparatus or digital camera to which the prism optical system according to one embodiment is applied.

### DESCRIPTION OF EMBODIMENTS

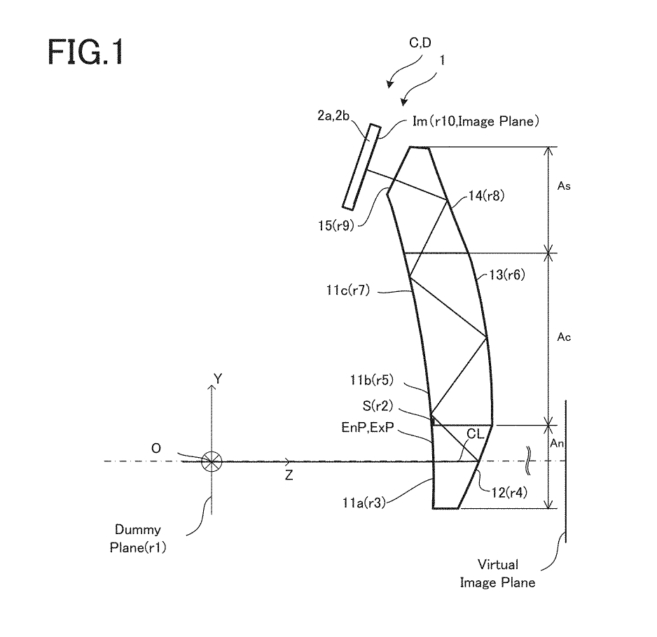

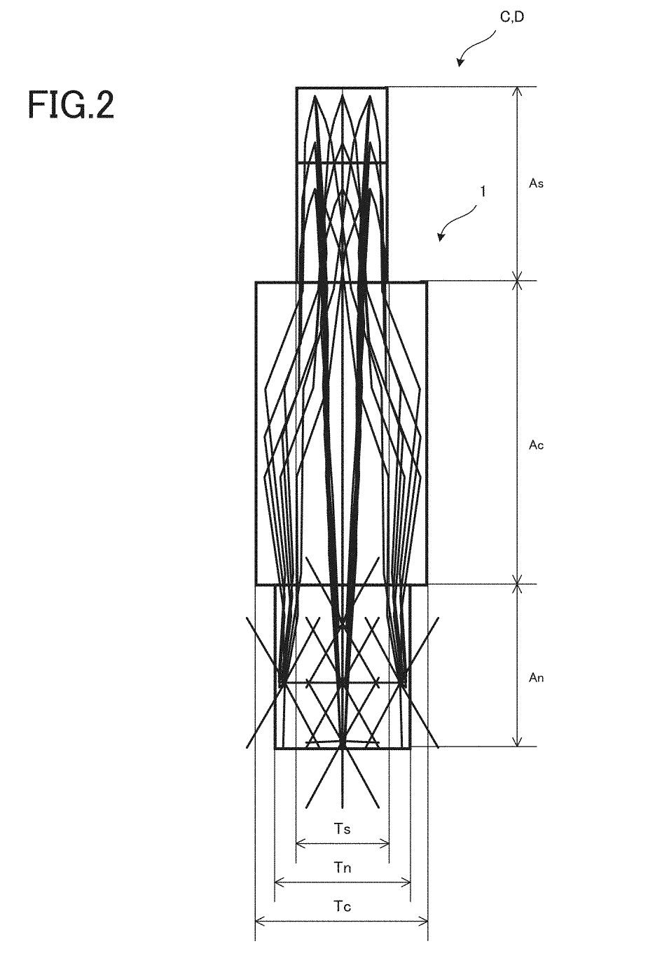

FIG. 1 is illustrative in arrangement of the prism optical system according to one embodiment, and FIG. 2 is illustrative in the X-Y section arrangement of the prism optical system according to one embodiment.

In a prism optical system 1 according to one embodiment used as an imaging apparatus C, light rays passing through an entrance pupil EnP of the prism optical system 1 are incident on the prism optical system 1 and imaged on an imaging plane or image plane Im of an imaging device 2a via the prism optical system 1, forming a real image. In the prism optical system 1 used as an image display apparatus D, on the other hand, light rays exiting out of a display plane or image plane Im of an image display device 2b enter the prism optical system 1 to form an exit pupil ExP via the prism optical system 1. The light rays are then incident on the eyeball of a viewer in the vicinity of or in front of that exit pupil ExP, forming an enlarged virtual image. Back ray tracing then works for convenience of designing; in that case, the prism optical system may be perceived as the same optical system as the imaging system. In this embodiment, the optical system is described with reference to forward ray tracing for the imaging system, and with reference to back ray tracing for the display system.

Referring here to a coordinate system for one embodiment, suppose that with a dummy plane set as a virtual pupil position of the viewer, the Z-axis positive direction is defined by a direction along the direction of travel of a center chief ray CL that passes from an origin included in that dummy plane through the center of the entrance pupil and is perpendicular to a surface that forms the entrance pupil, the Y-Z plane is defined by a plane including the Z-axis and the center of the image plane 2, and a Y-axis positive direction comes close to a direction from the origin toward the center of the image plane 2, an X-axis positive direction is defined by a direction that forms a right-handed orthogonal coordinate system with the Y-axis and the Z-axis.

With the prism optical system 1 according to the embodiment described herein, the single optical element 10 that is extremely small and lightweight, and has a high degree of freedom in shape can be used to image an external-world object by the imaging device 2a by way of the entrance pupil EnP and project an image from the image display device 2b onto the viewer's eyeball as a virtual image. This prism optical system 1 also makes it possible to take or project an image that is well corrected for aberrations inclusive of off-axis ones, has a high resolving power as far as the periphery of a screen involved, and is less distorted.

To this end, the prism optical system 1 described herein has an optical element 10 including at least three optical surfaces, each having an optical action, wherein after subjected to at least three reflections, incident light exits out, forming an image. The optical element 10 includes an entrance-side reflecting surface 12 having reflection on the most entrance side of the optical element 10 on an optical path, an exit-side reflecting surface 14 having reflection on the most exit side of the optical element 10 on the optical path, and intermediate reflecting surfaces 11b, 11c and 13 having reflection between the entrance-side reflecting surface 12 and the exit-side reflecting surface 14 on the optical path, and the thickness Tc of an intermediate area Ac including the intermediate reflecting surfaces 11b, 11c and 13 in the X-Z plane is greater than the thickness Tn of an entrance-side area An including the entrance-side reflecting surface 12 or the thickness Ts of an exit-side area including the exit-side reflecting surface 14.

According to the prism optical system 1 described herein, it is possible to make effective use of the optical functions of the respective surfaces that form the prism made up of at least three optical surfaces, in which prism light rays passing through the entrance pupil EnP have multiple reflections for guidance to the image plane Im. This results in an increased degree of freedom in prism shape so that the relative positions of the image plane Im and pupil, and the angle of incidence and exit angle of light rays can be determined as desired.

The surface of the optical system, out of which light exits when it is used as an image display apparatus D and on which light is incident when it is used as an imaging apparatus C, do not only have transmission but also have internal reflection so that the transmitting area can overlap with the reflecting area in the prism. Further, if that surface is designed to have two internal reflections or there are two reflections by a single surface, it is then possible for two reflecting areas to overlap each other while being oblivious to any surface-to-surface seam. It is thus possible to make the prism optical system 1 itself compact, working in favor of apparatus's size and weight reductions.

In the form of the imaging apparatus, the diameter of a light beam incident on the prism optical system 1 through the entrance pupil EnP is determined by the diameter of the entrance pupil, and the angle of the light beam incident on the pupil is determined by a preset angle of view as well. All light beams passing through the entrance surface 11a of the prism optical system 1 that is a transmitting surface located on the most object side is subjected to first reflection off the entrance-side reflecting surface 12, traveling toward the intermediate reflecting surface 13. Light is then internally reflected off one or multiple intermediate reflecting surfaces 11b, 11c and 13 and finally reflected off the exit-side reflecting surface 14, exiting out of the prism exit surface 15 for imaging on the image plane.

In that case, how axial rays behave depends on the power layout of the optical system (the locations and powers of the respective surfaces in the case of the prism optical system 1), and a light beam usually gets narrow as it travels from the entrance surface 11a toward the image plane Im. In the form of a high-resolution optical system, on the other hand, it is required to increase the diameter of a light beam in an intermediate position so as to make the numerical aperture large. In some case, the light beam may be likely to spread from the entrance surface 11a and then get narrow.

The same also holds for off-axis light rays; however, a light beam travels outward for a portion of the angle of view, and marginal rays in particular often tend to gain more height on the intermediate reflecting surfaces 11b, 11c and 13 rather than on the entrance-side reflecting surface 12. In some case, the intermediate reflecting surfaces 11b, 11c and 13 have more effective height than the entrance-side reflecting surface 12 has.

In the X-Z plane, therefore, the intermediate area is preferably thicker than the entrance-side area As. This results in ability to reduce the volume and weight of the optical element 10 because off-axis light beams are not blocked off with a partially minimized thickness.

In the exit-side area, the diameter of a light beam becomes narrow due to its proximity to the image plane Im, as described above; the depending rays of axial rays have less height on the exit-side reflecting surface 14 rather than on the intermediate reflecting surfaces 11b, 11c and 13. The same holds for the depending rays of off-axis rays. In other words, the intermediate reflecting surfaces 11b, 11c and 13 often have more effective height than the exit-side reflecting surface 14 has.

In the X-Z plane, therefore, the intermediate area is preferably thicker than the exit-side area. This results in ability to reduce the volume and weight of the optical element 10 because off-axis light beams are not blocked off with a partially minimized thickness.

Use of such compact optical element 10 in the form of the image display apparatus D helps clear the wearer of a sense of discomfort and troublesomeness, and use of it in the form of the imaging apparatus C ends up with some contribution to apparatus's size and weight reductions.

Especially with the inventive prism optical system 1 used in the form of a viewing optical system, the thicknesses in the X-Z plane of the entrance-side area An in which the entrance-side reflecting surface 12 of the prism optical system 1 is included and the exit-side area As in which the exit-side reflecting surface 14 is included are preferably less than that of the intermediate area Ac in which the intermediate reflecting surfaces are included, as determined by back ray tracing, because a portion of the optical system positioned just in front of the eyes is so slimmed down that surrounding external-world images are easy to view. Further, if the optical system is more slimmed down than the diameter of a human's pupil, it is then possible to view enlarged electronic images upon projection and, at the same time, view external-world images too.

On the exit side, on the other hand, there is the need for disposing a display device in an image plane position, providing that display device with an electric circuit for image displays and putting a member such as a holder mechanism in place, which leads up to an increase in the size of the viewing optical system. If the thickness in the X-Z plane of an area of the optical system from the exit-side reflecting surface 14 up to the most exit-side transmitting surface 15 is reduced, however, it is then possible for the whole apparatus to be relatively slimmed down even with the provision of members other than the optical element like the display device.

In the prism optical system 1 here, the optical surfaces, each having an optical action, are mutually decentrated, and at least two out of the at least three optical surfaces are each defined by a rotationally asymmetric surface.

Reference is here made to the merits obtained from the use of such a decentered optical system in general, and the internal-reflection decentered prism in particular. A refracting optical element like a lens is allowed to have power for the first time by imparting curvature to its boundary surface. Accordingly, upon refraction of light rays at that boundary surface, there are chromatic aberrations unavoidably produced due to the chromatic dispersion of the refracting optical element. As a result, another refracting optical system is commonly added to the first-mentioned optical element for the purpose of correcting chromatic aberrations.

On the other hand, a reflecting optical element such as a mirror or prism is principally free of chromatic aberrations even with power imparted to its reflecting surface, eliminating the need for adding another optical element to it only the purpose of correcting chromatic aberrations. For this reason, the optical system using the reflecting optical element could have a more reduced optical elements count than an optical system using the refracting optical element in view of correction of chromatic aberrations.

At the same time, the reflecting optical system using the reflecting optical element could be more reduced in its own size than the refracting optical system because the optical path involved can be folded up. However, the reflecting surface is required to have higher precision for assembling adjustment because of having higher sensitivity to decentration errors than the refracting surface.

For a prism among the reflecting optical elements, however, it is unnecessary to have higher assembling precision and more adjustment steps than required, because its respective surfaces take relatively fixed positions so that decentration can be controlled by itself. In addition, the prism includes an entrance surface and an exit surface, both being refracting surfaces, plus a reflecting surface; so it has greater flexibility in correction of aberrations than a mirror having only a reflecting surface. In particular, if a substantial portion of the desired power is allocated to the reflecting surface and the powers of the refracting surfaces or the entrance surface and exit surface are kept low, it is then possible to make chromatic aberrations much lower in sharp contrast to the refracting optical element such as a lens while the degree of freedom in correction of aberrations is kept higher than could be achieved with the mirror. Moreover, the prism is filled inside with a transparent medium higher in refractive index than air so that the optical path can be taken longer than in air, making the optical system thinner and smaller than could be achieved with a lens or mirror located in air. Referring here to a viewing optical system, it is required to have good imaging capability as far as its periphery, to say nothing of that at its center.

A single decentered prism used in the embodiment here is at least made up of an entrance surface 11a through which light enters the prism, an entrance-side reflecting surface 12 where a light beam incident through that entrance surface 11a is internally reflected off, intermediate reflecting surfaces 11b, 11c and 13 where the light beam reflected off the entrance-side reflecting surface 12 is internally reflected off, an exit-side reflecting surface 14 where the light beam reflected off the intermediate reflecting surfaces 11b, 11c and 13 is internally reflected off, and an exit-side surface 15 out of which the light beam reflected off the exit-side reflecting surface 14 exits, and at least two of these optical surfaces are configured in such a rotationally asymmetric curved surface shape as to impart an optical power to a light beam and have correction of decentration aberration so that just only aberrations at the center but also off-axis aberrations can be well corrected. Note here that the entrance surface 11a and the intermediate surfaces 11b, 11c and 13 may be the same or, alternatively, the entrance-side surface 12, exit-side reflecting surface 14 and intermediate reflecting surfaces 11b, 11c and 13 may be the same.

With such a basic arrangement, it is possible to achieve a small-format image display apparatus that is more reduced in terms of an optical elements count than an optical system using a refracting optical system or a rotationally symmetric imaging optical system, and has good performance from the center as far as the periphery thereof. For back ray tracing, suppose here that the axial chief ray is defined by a light ray passing through the center of the exit pupil of the image display device and arriving at the center of the display surface of the image display device. Unless at least one reflecting surface of the decentered prism is decentered with respect to the center chief ray, the incident and reflected chief rays will take the same optical path: they will be interrupted or shielded in the optical system. As a result, only the light beam shielded off at the center will be imaged; so the center will get dark or no image will be formed at the center whatsoever. As a matter of course, a powered reflecting surface may be decentered with respect to the center chief ray.

In one embodiment here, the reflecting surfaces forming a part of the decentered prism in the projection optical system are configured in such rotationally asymmetric curved surface shape as to give optical power to light beams and make correction of decentration aberrations, as described above. Such surface shape is preferable for correction of decentration aberrations. The reasons will be described in details just below.

In general, a lens system composed of a spherical lens alone is designed such that spherical aberrations produced at the spherical surfaces are mutually corrected with aberrations such as coma and field curvature at some surfaces thereby reducing those aberrations as a whole. In order to make good correction of aberrations at a fewer surfaces, on the other hand, rotationally asymmetric surfaces or the like may be used. This is to reduce aberrations produced at spherical surfaces on their own. With a decentered optical system, however, aberrations (decentration aberrations) produced by decentration of optical surfaces cannot be corrected by means of a rotationally symmetric optical system. Included in those decentration aberrations are just only asymmetric distortion and field curvature but also longitudinal astigmatism and coma.

Rotationally asymmetric field curvature is first explained. Light rays incident from an infinite object point on a decentered concave mirror are reflected off and imaged there, and once they have struck upon the concave mirror, the back focal length up to the image plane will become half the radius of curvature of a mirror portion upon which the light rays have struck in the case where there is air on the image side, whereupon the light reflected off the decentered concave surface forms an image plane that tilts with respect to the axial chief ray. It is thus impossible to correct the rotationally asymmetric field curvature with the rotationally symmetric optical system.

In order for the tilting field curvature to be corrected with the concave mirror itself that is the source of producing it, the concave mirror must be built up of a rotationally asymmetric surface. In this case, if the curvature gets tight in the Y-axis positive direction (the refracting power gets strong) and the curvature gets weak in the Y-axis negative direction (the refracting power gets weak), it is then possible to correct that field curvature. If, apart from the concave mirror, a rotationally asymmetric surface having the same action as in the aforesaid arrangement is interposed in the optical system, it is then possible to obtain a flat image plane with a fewer surfaces. For correction of aberrations, the rotationally asymmetric surface should preferably be configured in rotationally asymmetric surface shape having no rotationally symmetric axis both within and without its plane, because of increased flexibility.

Then, the rotationally asymmetric astigmatism is explained. The decentered concave mirror also produces such astigmatism with respect to the axial light ray in the same way as described above. This astigmatism could be corrected by proper changing of the refracting powers of the rotationally asymmetric surface in the X- and Y-axis directions in the same way as described above.

Further, the rotationally asymmetric coma is explained. The decentered concave mirror also produces coma with respect to the axial light ray in the same way as described above. This coma could be corrected by changing the tilt of the rotationally asymmetric surface with an increasing distance from the origin of its X-axis and properly changing the tilt of the surface depending on the positive and negative of the Y-axis. The imaging optical system could be designed such that at least one surface having the aforesaid reflection feature is decentered with respect to the axial chief ray and the rotationally asymmetric surface shape is allowed to have power. With such an arrangement, power is imparted to that reflecting surface so that decentration aberrations produced there can be corrected with that surface itself, and the power of the refracting surface of the prism is so slackened that chromatic aberrations can be reduced on their own.

In the prism optical system 1 of the embodiment described here, the entrance-side reflecting surface 12 and at least one out of the intermediate reflecting surfaces 11b, 11c and 13 or the exit-side reflecting surface 14 and at least one out of the intermediate reflecting surfaces 11b, 11c and 13 are the same.

With two such reflections off a single surface, it is possible to overlap two reflecting areas each other while being oblivious to any surface-to-surface seam. It is thus possible to make the prism optical system 1 itself compact, contributing effectively to apparatus's size and weight reductions.

In the prism optical system 1 of the embodiment described here, the entrance-side reflecting surface 12, the exit-side reflecting surface 14 and at least one out of the intermediate reflecting surfaces 11b, 11c and 13 are the same.

With three such reflections off a single surface, it is possible to overlap three reflecting areas each other while being oblivious to any surface-to-surface seam. It is thus possible to make the prism optical system 1 itself compact, contributing effectively to apparatus's size and weight reductions.

In the prism optical system 1 of the embodiment described here, the entrance surface 11a that is a transmitting surface located on the most entrance side on the optical path has a negative power.

The entrance surface 11a also serves as the internal reflecting surfaces 11b and 11c, and the entrance-side area An and intermediate reflecting area Ac often overlap each other. In that case, the internal reflection is preferably total reflection having an angle of incidence greater than the critical angle. Without recourse to total reflection, it is required to count on a special surface treatment such as half-mirror coating, which leads up to cost increases. In addition, that HM coating gives rise to a large decrease in the quantity of light under the actions of partial transmission and partial reflection. Satisfaction of the aforesaid total-reflection conditions ends up with no or little decrease in the quantity of light because there is theoretically neither transmission loss nor reflection loss at all.

The prism optical system 1 as described here should satisfy the following condition (1):

0.5<Tn/Tc<1.0 (1)

where Tn is the thickness of the entrance-side area An including the entrance-side reflecting surface 12, and Tc is the thickness of the intermediate area Ac including the intermediate reflecting surfaces.

Satisfaction of condition (1) allows the thickness Tn of the entrance-side area An to get small or, in another parlance, a member for covering up the eyes in front of the pupils to become slim, making it easy to perceive external-world images. Exceeding the upper limit to condition (1) causes the thickness Tn of the entrance-side area An to become greater than the thickness Tc of the intermediate area AC; the member in front of the eyes gets thicker, so the range of viewing an external world gets narrow. Being less than the lower limit to condition (1) is likely to shield off effective light rays. As the width of effective light rays per se get narrow, it causes the entrance pupil EnP to get too small for the image display apparatus to be hard to view, and for the imaging apparatus C to have a low NA or get dark during viewing.

In addition, the prism optical system 1 should preferably satisfy the following condition (1)′:

0.5<Tn/Tc<0.9 (1)′

Satisfaction of condition (1)′ allows the thickness Tc of the entrance-side area Ac to get smaller or, in another parlance, the member for covering up the eyes in front of the pupils to get thinner, making it easier to perceive external-world images.

The prism optical system 1 as described here should satisfy the following condition (2):

0.3<Ts/Tc<1.0 (2)

where Ts is the thickness of the exit-side area As including the exit-side reflecting surface 14, and Tc is the thickness of the intermediate area including the intermediate reflecting surfaces 11a, 11b and 13.

Exceeding the upper limit to condition (2) causes the thickness Ts of the exit-side area As to become greater than the thickness Tc of the intermediate area Ac; so the thickness of the member located just before the display device or imaging device increases, resulting in an increase in the whole size of the apparatus. Being less than the lower limit to condition (2) gives rise to a risk of shielding off effective light rays, and as the width of effective light rays per se becomes small, it causes light rays in the respective light beams not to spread out. Consequently, the entrance pupil gets too small for the image display apparatus D to be difficult to view, and for the imaging apparatus C to have a small NA or get dark during viewing.

In addition, the prism optical system 1 should preferably satisfy the following condition (2)′:

0.4<Ts/Tc<0.9 (2)′

Setting the upper limit to 0.9 causes the thickness Ts of the exit-side area As to get smaller, and a portion, to which a fixing member for locating a member such as the display device and the optical element in a given position is connected, to remain more slimmed down, rendering the whole apparatus more compact. Setting the lower limit to 0.4 allows the image display apparatus D to be easier to view, and the imaging apparatus C to have a higher NA and get brighter during viewing.

Preferably, the image display apparatus D has a prism optical system 1 including an optical element 10 and an image display device 2b located in opposition to the exit surface on the optical path for back ray tracing of the optical element 10, and viewer's eyes are located in opposition to the entrance surface on the optical path for back ray tracing of the optical element 10 to present an enlarged virtual image to the viewer.

Light emanating from the image display device 2b takes a back ray tracing optical path: it enters the prism optical system 1 from the fifth surface 15, is internally reflected off at least three times, and exits out of the entrance surface 11 as substantial parallel light, entering the pupils of the viewer's eyeballs.

According to the image display apparatus D having such an arrangement, it is possible for the viewer to view an enlarged virtual image.

Preferably, the exit pupil is formed in the vicinity of an exit window of the first surface of the prism optical system 1 or between the first surface 11a and the viewer's eyeballs.

As the exit pupil of the image display device 2 is formed in the vicinity of an exit window of the first surface 11a of the prism optical system 1 or between the entrance-side reflecting surface 12 and the viewer's eyeballs, it is possible to reduce shadings of marginal light beams of an image under observation. According to the image display apparatus D of such an arrangement, it is possible for the viewer to take a view of images that remain clear-cut as far as the periphery of the screen involved.

The imaging apparatus C according to the invention described herein has a prism optical system 1 including an optical element 10, an imaging device 2a located in opposition to the exit surface of the optical element 10 on the optical path, and an aperture stop S located on, or in the vicinity of, the entrance surface of the optical element 10 on the optical path to take an external-world image.

An aperture stop S having a circular aperture is located underneath and near the entrance surface 11 of the prism optical system 1, and an imaging device such as CCD is located in opposition to the exit surface 15 so that light incident on the prism from its entrance surface 11a after passing through the aperture stop S is internally reflected off at least three times, exiting out of the exit surface 15, and arriving at the imaging device for convergence.

According to such an arrangement, it is possible to achieve the imaging apparatus C that is reduced in terms of size and weight.

In what follows, the prism optical system 1 described herein will be explained with reference to examples.

The setup parameters of these optical systems will be described later. Suppose here that as shown typically in FIG. 1, a position (pupil position) where the viewer takes a look of images is defined as the dummy plane of the prism optical system 1. These parameters are based on the results of back ray tracing wherein light rays passing through the dummy plane travel through the prism optical system 1 toward the image display device 2b.

Referring to the coordinate system here, as depicted in FIG. 1, the point O of intersection of the dummy plane r1 with the center chief ray CL is defined as the optical origin O of the decentered optical surface of a decentered optical system. Then, a direction of the center chief ray CL from the origin O toward the prism optical system 1 side is defined as the Z-axis positive direction; the direction orthogonal to the Z-axis on the image display device 2 side from the origin O is defined as the Y-axis positive direction; and the sheet plane of FIG. 1 is defined as the Y-Z plane. Then, an axis that forms a right-handed orthogonal coordinate system with the Y- and Z-axes is defined as the X-axis positive direction.

Given to each decentered surface are the amount of decentration of the coordinate system, on which that surface is defined, from the center of the origin of the optical system (X, Y and Z in the X-, Y- and Z-axis directions) and the angles (α, β, γ(°)) of tilt of the coordinate system for defining each surface about the X-, Y- and Z-axes of the coordinate system defined on the origin of the optical system. In that case, the positive α and β mean counterclockwise rotation with respect to the positive directions of the respective axes, and the positive γ means clockwise rotation with respect to the positive direction of the Z-axis. Referring to the α, β, γ rotation of the center axis of a certain surface, the coordinate system for defining each surface is first α rotated counterclockwise about the X-axis of the coordinate system defined on the origin of the coordinate system. Then, it is β rotated counterclockwise about the Y-axis of the thus rotated, new coordinate system, and finally γ rotated clockwise about the Z-axis of the thus rotated, new another coordinate system.

When a specific surface of the optical function surfaces forming the optical system of each example and the subsequent surface form together a coaxial optical system, there is a surface separation given. Besides, the radii of curvature of the surfaces, and the refractive indices and Abbe constants of the media are given as usual.

It is also noted that coefficient terms to which no data are given in the following setup parameters are zero. The refractive indices and Abbe constants on a d-line basis (587.56 nm wavelength) are given, and length is given in mm. The decentration of each surface is represented by the quantity of decentration from the reference surface, as mentioned above.

The surface shape of the free-form surface used in the embodiments is defined by the following formula (a). Note here that the Z-axis in that defining formula stands for the axis of the free-form surface.

$$Z = ( {r}^{2} / R ) [ 1 + √ \{ 1 - ( 1 + k ) ( r / {R}^{2} \} ] + {\sum }_{j = 1}^{∞} {C}_{j} {X}^{m} {Y}^{n} \qquad ( a )$$

Here the first term of Formula (a) is the spherical term, and the second term is the free-form surface term.

In the spherical term,

R is the radius of curvature of the apex,

k is the conic constant, and

r is √(X²+Y²).

The free-form surface term is:

$${\sum }_{j = 1}^{66} {C}_{j} {X}^{m} {Y}^{n} = {C}_{1} + {C}_{2} X + {C}_{3} Y + {C}_{4} {X}^{2} + {C}_{5} XY + {C}_{6} {Y}^{2} + {C}_{7} {X}^{3} + {C}_{8} {X}^{2} Y + {C}_{9} {XY}^{2} + {C}_{10} {Y}^{3} + {C}_{11} {X}^{4} + {C}_{12} {X}^{3} Y + {C}_{13} {X}^{2} {Y}^{2} + {C}_{14} {XY}^{3} + {C}_{15} {Y}^{4} + {C}_{16} {X}^{5} + {C}_{17} {X}^{4} Y + {C}_{18} {X}^{3} {Y}^{2} + {C}_{19} {X}^{2} {Y}^{3} + {C}_{20} {XY}^{4} + {C}_{21} {Y}^{5} + {C}_{22} {X}^{6} + {C}_{23} {X}^{5} Y + {C}_{24} {X}^{4} {Y}^{2} + {C}_{25} {X}^{3} {Y}^{3} + {C}_{26} {X}^{2} {Y}^{4} + {C}_{27} {XY}^{5} + {C}_{28} {Y}^{6} + {C}_{29} {X}^{7} + {C}_{30} {X}^{6} Y + {C}_{31} {X}^{5} {Y}^{2} + {C}_{32} {X}^{4} {Y}^{3} + {C}_{33} {X}^{3} {Y}^{4} + {C}_{34} {X}^{2} {Y}^{5} + {C}_{35} {XY}^{6} + {C}_{36} {Y}^{7}$$

where Cⱼ is a coefficient (j is an integer greater than 1).

Generally, although the aforesaid free-form surface has not possibly a surface of symmetry in both the X-Z and Y-Z planes, yet it will have only one surface of symmetry parallel with the Y-Z plane by reducing all the odd-numbered terms for X down to zero. For instance, this may be achieved by reducing the coefficients C₂, C₅, C₇, C₉, C₁₂, C₁₄, C₁₆, C₁₈, C₂₀, C₂₃, C₂₅, C₂₇, C₂₉, C₃₁, C₃₃, C₃₅, . . . in the aforesaid defining formula (a) down to zero.

Also, by reducing all the odd-numbered terms for Y down to zero, for instance, by reducing C₃, C₅, C₈, C₁₀, C₁₂, C₁₄, C₁₇, C₁₉, C₂₁, C₂₃, C₂₅, C₂₇, C₃₀, C₃₂, C₃₄, C₃₆ . . . in the aforesaid defining formula down to zero, the free-form surface will have only one surface of symmetry parallel with the X-Z plane.

If the optical system is decentered in any one direction of the aforesaid surfaces of symmetry, for instance, the Y-axis direction with respect to the surface of symmetry parallel with the Y-Z plane, and the X-axis direction with respect to the surface of symmetry parallel with the X-Z plane, it is then possible to improve assembling capability while making effective correction for rotationally asymmetric aberrations occurring from decentration.

It is here to be noted that the aforesaid defining formula (a) is provided for the purpose of illustration alone. The free-form surface according to the invention has a feature of using a rotationally asymmetric surface thereby making correction for rotationally asymmetric aberrations occurring from decentration while, at the same time, improving assembling capabilities. As a matter of course, the same effect is achievable for any other defining formula too.

Further, the aspheric data presented herein include those about aspheric surface data. The aspheric surface shape is represented by the following formula with the proviso that z is an optical axis with the direction of travel of light taken as positive and y is a direction orthogonal to the optical axis.

z=(y²/r)/[1+{1−(1+K)·(y/r)²}^{1/2}]+A4y⁴+A6y⁶+A8y⁸+A10y¹⁰ . . .

In the aforesaid formula, r is a radius of paraxial axis, K is the conic coefficient, and A4, A6 and A8 are the fourth, sixth and eighth-order aspheric coefficients, respectively. Note here that the symbol “e” indicates that the numerical value subsequent to it is a power exponent with 10 as a base; for instance “1.0e-5” stands for “1.0×10⁵”.

Examples of the embodiments described herein will now be explained.

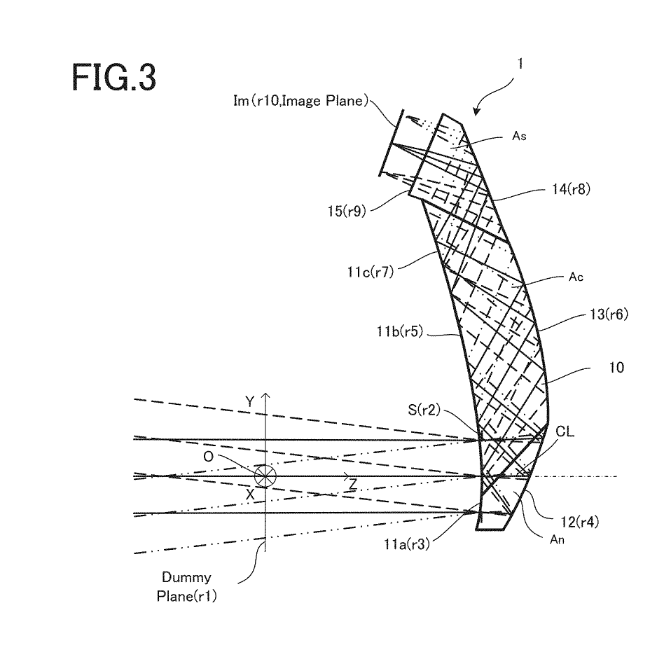

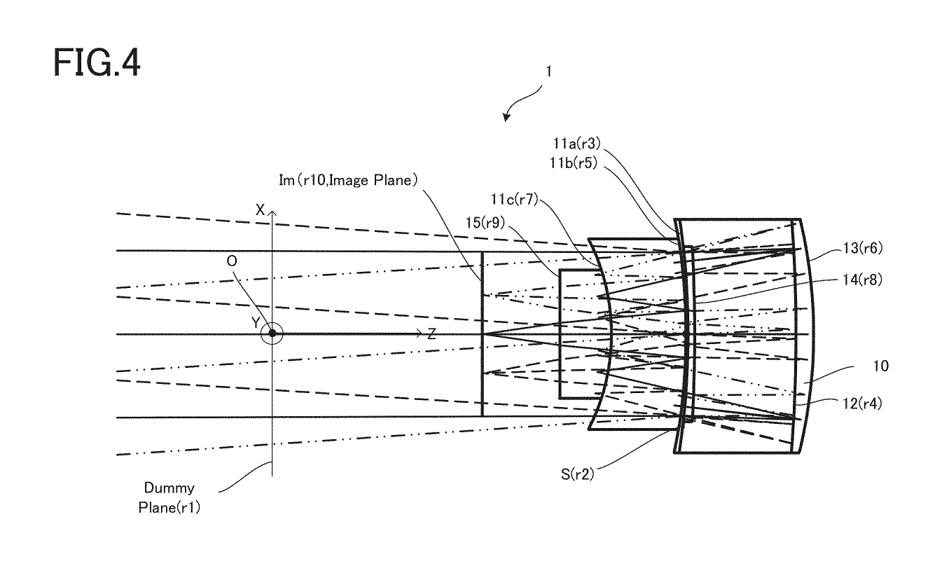

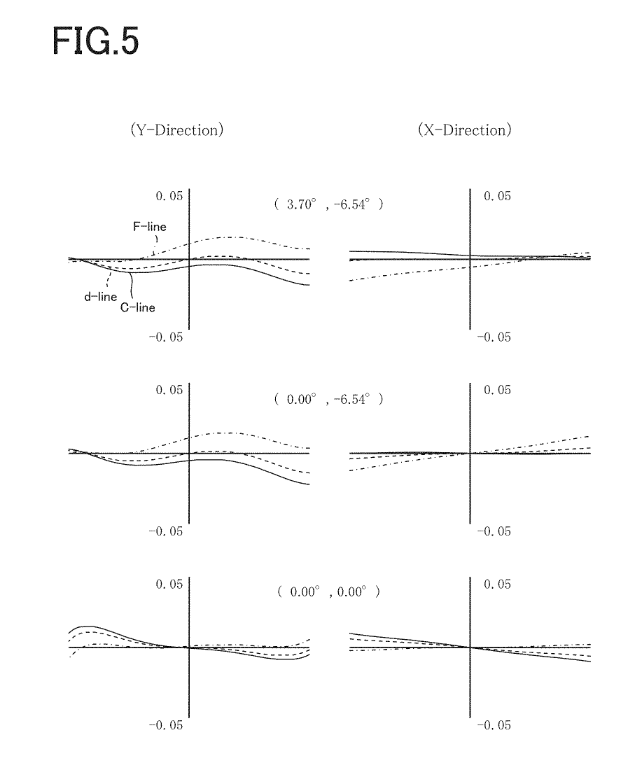

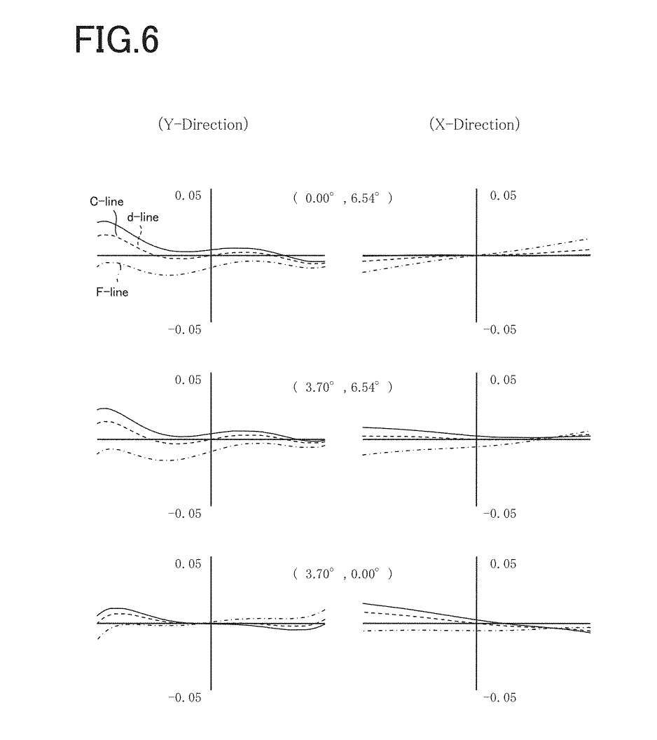

FIG. 3 is an optical path diagram in the Y-Z section for the prism optical system of Example 1 according to one embodiment. FIG. 4 is an optical path diagram in the X-Z section for the prism optical system of Example 1 according to one embodiment. FIGS. 5 and 6 are sets of transverse aberration diagrams for the whole prism optical system of Example 1 according to one embodiment.

It is here to be noted that in the aberration diagrams, d-line (solid line), F-line (chain line) and C-line (dashed line) are indicative of wavelengths of 587.6 nm, 486.1 nm and 656.3 nm, respectively, as will apply to the subsequent examples.

On an optical path through an imaging system, the prism optical system 1 of Example 1 includes an optical element 10 made up of a first surface 11 including an entrance surface 11a and intermediate reflecting surfaces 11b and 11c defined by internal reflecting surfaces, a second surface 12 that is located in opposition to the first surface 11 and acts as an entrance-side reflecting surface, a third surface 13 that is located in opposition to the first surface 11 and adjacent to the second surface 12 and acts as an internal reflecting surface, a fourth surface 14 that is located in opposition to the first surface 11 and adjacent to the third surface 13 and acts as a combined internal and exit-side reflecting surface, and a fifth surface 15 that acts as an exit surface on the optical path adjacent to the first surface 11 and in opposition to the fourth surface 14.

The first 11, second 12, third 13 and fourth surface 14 are defined by free-form surfaces, each acting as a rotationally asymmetric surface.

In the imaging system, a light beam enters the optical element 10 through the entrance surface 11a included in the first surface 11, and is internally reflected off the entrance-side reflecting surface included in the second surface 12, then off the intermediate reflecting surface included in the third surface 13, then off the intermediate reflecting surface 11c included in the first surface 11 and then off the exit-side reflecting surface included in the fourth surface 14, and then exits out of the prism optical system 1 through the exit surface included in the fifth surface 15, forming an image on an image plane Im.

In back ray tracing through a display system, a light beam enters the optical element 10 through the exit surface included in the fifth surface 15, and is internally reflected off the exit-side reflecting surface included in the fourth surface 14, then off the intermediate reflecting surface 11c included in the first surface 11, then off the intermediate reflecting surface included in the third surface 13, then off the intermediate reflecting surface 11b included in the first surface 11 and then off the intermediate reflecting surface included in the second surface 12, then exiting out of the prism optical system 1 through the entrance surface 11a included in the first surface 11.

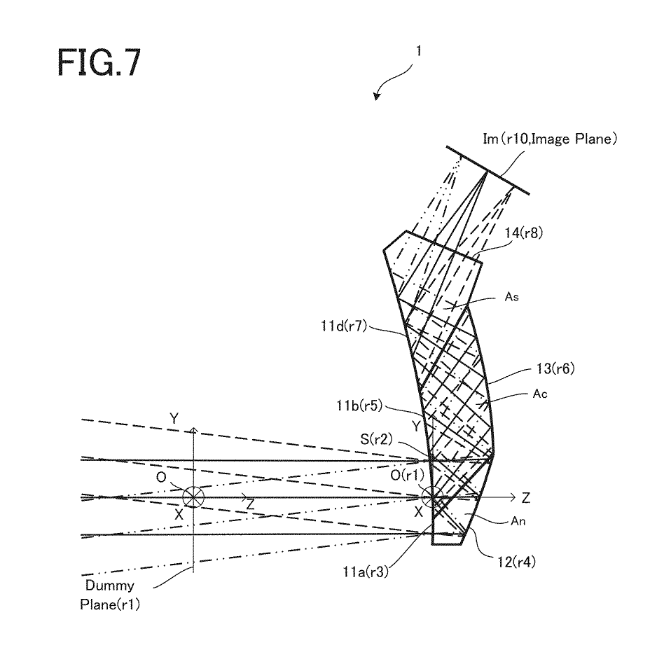

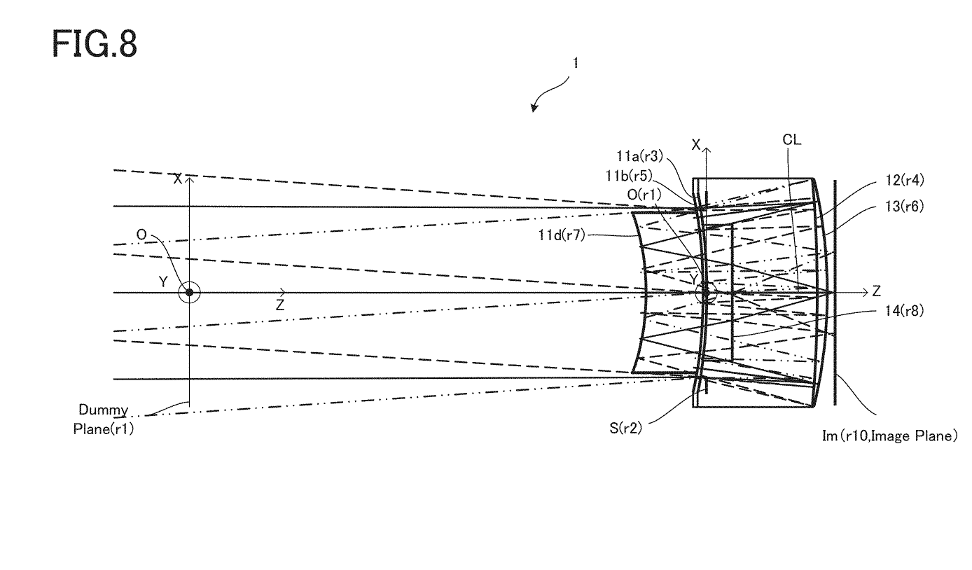

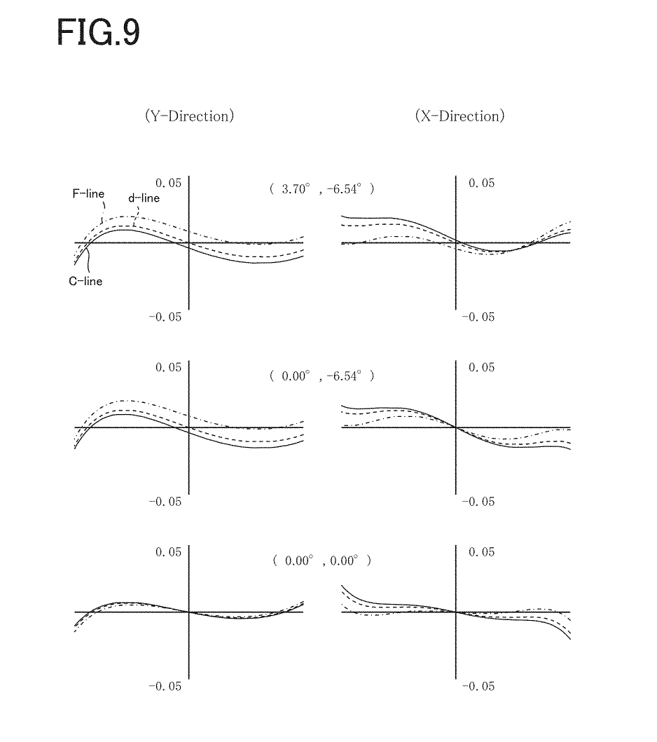

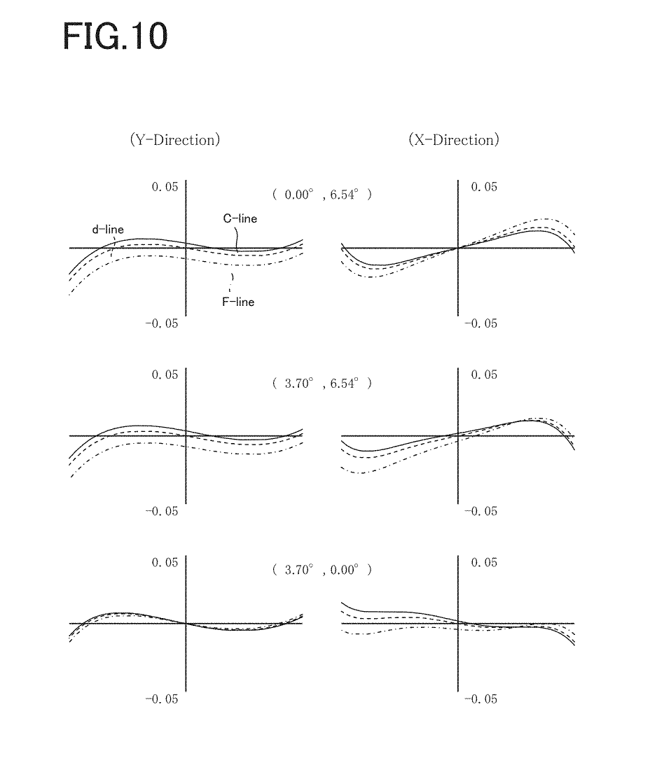

FIG. 7 is an optical path diagram in the Y-Z section for the prism optical system of Example 2 according to one embodiment. FIG. 8 is an optical path diagram in the X-Z section for the prism optical system of Example 2 according to one embodiment. FIGS. 9 and 10 are sets of transverse aberration diagrams for the whole prism optical system of Example 2 according to one embodiment.

The prism optical system 1 of Example 2 includes an optical element 10 made up of a first surface 11 including, on an optical path taken through the imaging system, an entrance surface 11a, an intermediate reflecting surface 11b that is an internal reflecting surface and an exit-side reflecting surface 11d that is a reflecting surface located on the most exit side, a second surface 12 that acts as an entrance-side reflecting surface that is located in opposition to the first surface 11 and on the most entrance side, a third surface 13 acting as an intermediate reflecting surface that is an internal reflecting surface in opposition to the first surface 11 and adjacent to the second surface 12, and a fourth surface 14 acting as an exit surface that is located in opposition to the exit-side reflecting surface 11d of the first surface 11 and adjacent to the third surface 13.

The first 11, second 12 and third surface 13 are defined by free-form surfaces, each in the form of a rotationally asymmetric surface.

In the imaging system, a light beam enters the optical element 10 through the entrance surface 11a included in the first surface 11, and is internally reflected off the entrance-side reflecting surface included in the second surface 12, then off the intermediate reflecting surface 11b included in the first surface 11, then off the intermediate reflecting surface included in the third surface 13 and then off the exit-side reflecting surface 11d included in the first surface 11, and then exits out of the prism optical system 1 through the exit surface included in the fourth surface 14, forming an image on an image plane Im.

In back ray tracing through the display system, a light beam enters the optical element 10 through the exit surface included in the fourth surface 14, and is internally reflected off the exit-side reflecting surface 11d included in the first surface 11, then off the intermediate reflecting surface included in the third surface 13 and then off the intermediate reflecting surface 11b included in the first surface 11 and then off the entrance-side reflecting surface included in the second surface 12, and then exits out of the prism optical system 1 through the entrance surface 11a included in the first surface 11.

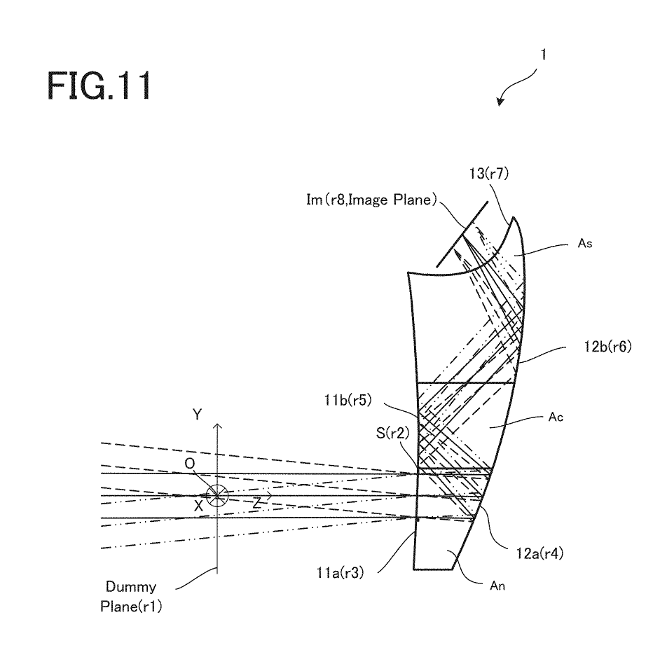

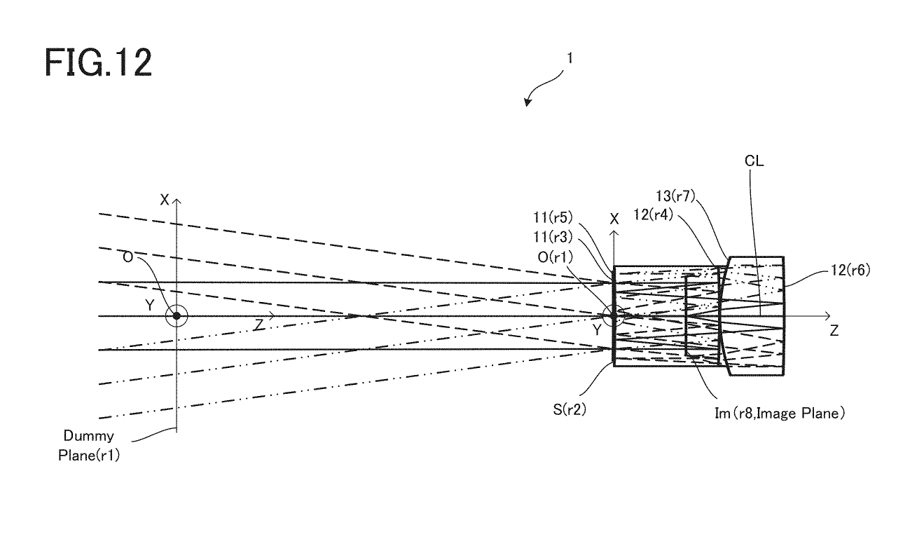

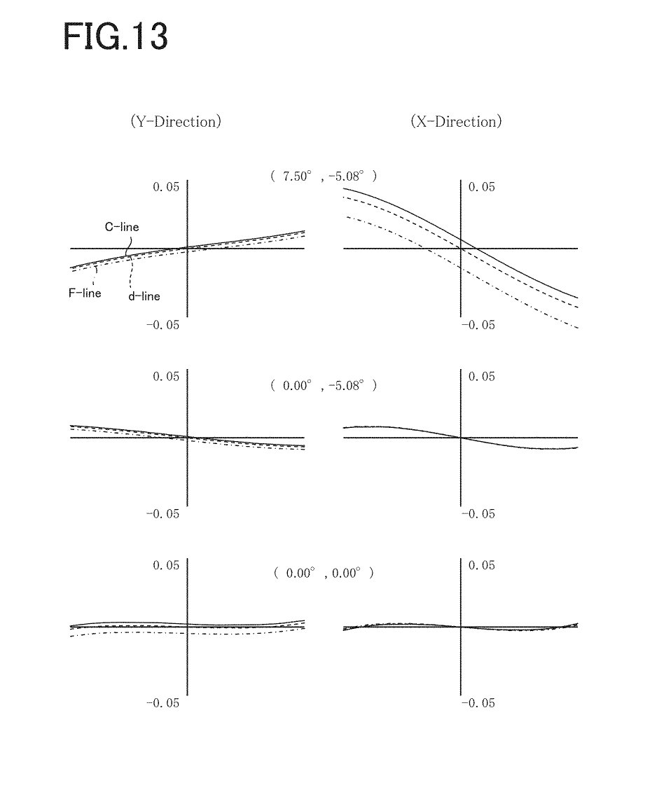

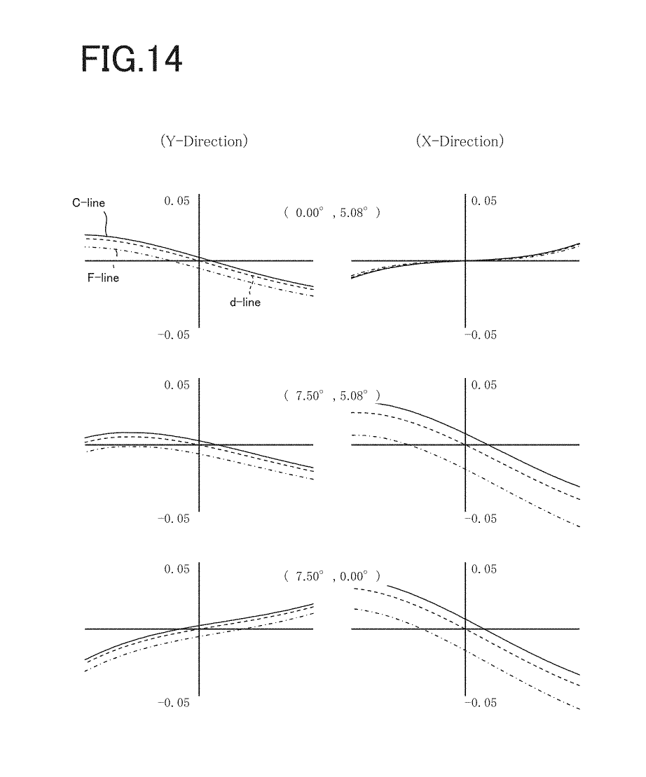

FIG. 11 is an optical path diagram in the Y-Z section for the prism optical system of Example 3 according to one embodiment. FIG. 12 is an optical path diagram in the X-Z section for the prism optical system of Example 3 according to one embodiment. FIGS. 13 and 14 are sets of transverse aberration diagrams for the whole prism optical system of Example 3 according to one embodiment.

The prism optical system 1 of Example 3 includes an optical element 10 made up of a first surface 11 acting as an entrance surface 11a that is a transmitting surface located on the most entrance side on the optical path and an intermediate reflecting surface 11b, a second surface 12 acting as entrance-side and exit-side reflecting surfaces 12a and 12b in opposition to the first surface 11, and a third surface 13 acting as a combined transmission and exit surface that is located adjacent to the first 11 and second surface 12 and on the most exit side.

The second 12, and the third surface 13 is defined by a free-form surface as a rotationally asymmetric surface, and the first surface 11 is defined by an aspheric surface.

In the imaging system, a light beam enters the optical element 10 through the entrance surface 11a included in the first surface 11, and is internally reflected off the entrance-side reflecting surface included in the second surface 12, then off the intermediate reflecting surface 11b included in the first surface 11 and then off the exit-side reflecting surface 12b included in the second surface 12, and then exits out of the prism optical system 1 through the exit surface included in the third surface 13, forming an image on an image plane Im.

In back ray tracing through the display system, a light beam enters the optical element 10 through the exit surface included in the third surface 13, and is internally reflected off the second surface 12 acting as the exit-side reflecting surface 12b, then off the intermediate reflecting surface 11b included in the first surface 11 and then off the exit-side reflection side 12b included in the second surface 12, and then exits out of the prism optical system 1 through the entrance surface 11a included in the first surface 11.

In what follows, setup parameters in the aforesaid Examples 1, 2 and 3 will be shown. Note here that “FFS” in the following tables is an abbreviation of the free-form surface.

### Example 1

| | Radius of | Surface | | Refractive | Abbe |
|---|---|---|---|---|---|
| Surface No. | Curvature | Separation | Decentration | Index | Constant |
| Object | ∞ | −1000.00 | | | |
| Surface | | | | | |
| 1 | ∞ (Dummy Place) | 0.00 | | | |
| 2 | Stop Surface | 0.00 | Decentration (1) | | |
| 3 | FFS[1] | 0.00 | Decentration (2) | 1.5254 | 56.2 |
| 4 | FFS[2] | 0.00 | Decentration (3) | 1.5254 | 56.2 |
| 5 | FFS[1] | 0.00 | Decentration (2) | 1.5254 | 56.2 |
| 6 | FFS[3] | 0.00 | Decentration (4) | 1.5254 | 56.2 |
| 7 | FFS[1] | 0.00 | Decentration (2) | 1.5254 | 56.2 |
| 8 | FFS[4] | 0.00 | Decentration (5) | 1.5254 | 56.2 |
| 9 | ∞ | 0.00 | Decentration (6) | | |
| 10 | ∞ | 0.00 | Decentration (7) | | |
| Image Plane | ∞ | 0.00 | | | |

FFS[1]

| | | | | | |
|---|---|---|---|---|---|
| C4 | −1.3402e−002 | C6 | −1.7657e−001 | C8 | 2.7289e−003 |
| C10 | 2.9057e−003 | C11 | −1.9224e−004 | C13 | −2.0376e−003 |
| C15 | −1.7505e−004 | C17 | 7.1627e−005 | C19 | 2.2069e−004 |
| C21 | 2.1308e−005 | C22 | −9.0441e−007 | C24 | −1.0841e−005 |
| C26 | −1.2337e−005 | C28 | −1.3293e−006 | | |

FFS[2]

| | | | | | |
|---|---|---|---|---|---|
| C4 | −8.2459e−003 | C6 | −1.7088e−002 | C8 | −7.5033e−004 |
| C10 | 1.0102e−003 | C11 | −1.0484e−005 | C13 | 3.9381e−005 |
| C15 | −7.5421e−005 | C17 | 5.3635e−008 | C19 | −1.5262e−006 |
| C21 | 2.8111e−006 | | | | |

FFS[3]

| | | | | | |
|---|---|---|---|---|---|
| C4 | −2.6005e−002 | C6 | −1.1451e−002 | C8 | −4.2703e−004 |
| C10 | 2.2631e−004 | C11 | −2.4754e−005 | C13 | −1.1650e−005 |
| C15 | −1.5880e−005 | C17 | −1.2142e−006 | C19 | −3.7262e−007 |
| C21 | 1.0548e−006 | C22 | −5.0257e−008 | C24 | −2.5619e−008 |
| C26 | 6.4305e−009 | C28 | −3.4263e−008 | | |

FFS[4]

| | | | | | |
|---|---|---|---|---|---|
| C4 | −9.6520e−003 | C6 | −1.5312e−003 | C8 | −1.4966e−004 |
| C10 | 2.9621e−005 | C11 | 4.2504e−005 | C13 | 3.7292e−005 |
| C15 | −4.9784e−006 | C17 | 4.6081e−006 | C19 | 6.7018e−007 |
| C21 | 1.7467e−007 | C22 | −5.2166e−007 | C24 | −9.7681e−007 |
| C26 | −4.2798e−007 | C28 | 2.9056e−007 | | |

Decentration [1]

| | | | | | |
|---|---|---|---|---|---|
| X | 0.00 | Y | 0.00 | Z | 18.00 |
| α | 0.00 | β | 0.00 | γ | 0.00 |

Decentration [2]

| | | | | | |
|---|---|---|---|---|---|
| X | 0.00 | Y | −7.00 | Z | 15.84 |
| α | −58.92 | β | 0.00 | γ | 0.00 |

Decentration [3]

| | | | | | |
|---|---|---|---|---|---|
| X | 0.00 | Y | −2.41 | Z | 20.90 |
| α | −26.70 | β | 0.00 | γ | 0.00 |

Decentration [4]

| | | | | | |
|---|---|---|---|---|---|
| X | 0.00 | Y | 8.06 | Z | 23.39 |
| α | 8.36 | β | 0.00 | γ | 0.00 |

Decentration [5]

| | | | | | |
|---|---|---|---|---|---|
| X | 0.00 | Y | 24.90 | Z | 18.07 |
| α | 21.98 | β | 0.00 | γ | 0.00 |

Decentration [6]

| | | | | | |
|---|---|---|---|---|---|
| X | 0.00 | Y | 26.76 | Z | 13.26 |
| α | −23.11 | β | 0.00 | γ | 0.00 |

Decentration [7]

| | | | | | |
|---|---|---|---|---|---|
| X | 0.00 | Y | 27.80 | Z | 10.39 |
| α | −20.00 | β | 0.00 | γ | 0.00 |

The X- and Y-direction angles of view are 7.4° and 13.1°, and the entrance pupil diameter is 6 mm.

### Example 2

| | Radius of | Surface | | Refractive | Abbe |
|---|---|---|---|---|---|
| Surface No. | Curvature | Separation | Decentration | Index | Constant |
| Object | ∞ | −1000.00 | | | |
| Surface | | | | | |
| 1 | ∞ (Dummy Place) | 0.00 | | | |
| 2 | Stop Surface | 0.00 | Decentration (1) | | |
| 3 | FFS[1] | 0.00 | Decentration (2) | 1.5254 | 56.2 |
| 4 | FFS[2] | 0.00 | Decentration (3) | 1.5254 | 56.2 |
| 5 | FFS[1] | 0.00 | Decentration (2) | 1.5254 | 56.2 |
| 6 | FFS[3] | 0.00 | Decentration (4) | 1.5254 | 56.2 |
| 7 | FFS[1] | 0.00 | Decentration (2) | 1.5254 | 56.2 |
| 8 | FFS[4] | 0.00 | Decentration (5) | 1.5254 | 56.2 |
| 9 | ∞ | 0.00 | Decentration (6) | | |
| 10 | ∞ | 0.00 | Decentration (7) | | |
| Image Plane | ∞ | 0.00 | | | |

FFS[1]

| | | | | | |
|---|---|---|---|---|---|
| C4 | 2.3512e−002 | C6 | −1.8454e−001 | C8 | −1.1118e−002 |
| C10 | 3.2149e−003 | C11 | 2.3426e−004 | C13 | −7.5806e−004 |
| C15 | 8.7273e−006 | C17 | −4.6410e−005 | C19 | 2.8567e−004 |
| C21 | 2.6397e−005 | C22 | −2.4510e−007 | C24 | 6.7266e−007 |
| C26 | −1.6843e−005 | C28 | −2.2892e−006 | | |

FFS[2]

| | | | | | |
|---|---|---|---|---|---|
| C4 | −1.2609e−002 | C6 | −7.2315e−003 | C8 | −3.8539e−006 |
| C10 | −9.1949e−005 | C11 | −1.1300e−005 | C13 | −1.0442e−005 |
| C15 | 2.0398e−006 | | | | |

FFS[3]

| | | | | | |
|---|---|---|---|---|---|
| C4 | −1.9017e−002 | C6 | −1.0219e−002 | C8 | −3.6396e−004 |
| C10 | −2.0903e−005 | C11 | −1.8047e−006 | C13 | −3.0333e−005 |
| C15 | −4.9276e−006 | C17 | 1.6834e−006 | C19 | −6.9522e−007 |
| C21 | 4.6685e−008 | | | | |

FFS[4]

| | | | | | |
|---|---|---|---|---|---|
| C4 | −1.0144e−002 | C6 | 2.5803e−003 | C8 | −7.5004e−004 |
| C10 | 1.2499e−004 | C11 | 4.3020e−005 | C13 | 3.4186e−005 |
| C15 | 2.0953e−005 | C17 | −4.8356e−007 | C19 | 6.4195e−006 |
| C21 | 4.0905e−006 | | | | |

Decentration [1]

| | | | | | |
|---|---|---|---|---|---|
| X | 0.00 | Y | 0.00 | Z | 18.00 |
| α | 0.00 | β | 0.00 | γ | 0.00 |

Decentration [2]

| | | | | | |
|---|---|---|---|---|---|
| X | 0.00 | Y | −11.60 | Z | 15.19 |
| α | −63.64 | β | 0.00 | γ | 0.00 |

Decentration [3]

| | | | | | |
|---|---|---|---|---|---|
| X | 0.00 | Y | −2.69 | Z | 20.60 |
| α | −24.49 | β | 0.00 | γ | 0.00 |

Decentration [4]

| | | | | | |
|---|---|---|---|---|---|
| X | 0.00 | Y | 15.20 | Z | 21.51 |
| α | 13.83 | β | 0.00 | γ | 0.00 |

Decentration [5]

| | | | | | |
|---|---|---|---|---|---|
| X | 0.00 | Y | 21.62 | Z | 19.18 |
| α | 21.06 | β | 0.00 | γ | 0.00 |

Decentration [6]

| | | | | | |
|---|---|---|---|---|---|
| X | 0.00 | Y | 23.33 | Z | 14.78 |
| α | −24.94 | β | 0.00 | γ | 0.00 |

Decentration [7]

| | | | | | |
|---|---|---|---|---|---|
| X | 0.00 | Y | 24.17 | Z | 12.39 |
| α | −19.37 | β | 0.00 | γ | 0.00 |

The X- and Y-direction angles of view are 7.4° and 13.1°, and the entrance pupil diameter is 6 mm.

### Example 3

| | Radius of | Surface | | Refractive | Abbe |
|---|---|---|---|---|---|
| Surface No. | Curvature | Separation | Decentration | Index | Constant |
| Object | ∞ | −1000.00 | | | |
| Surface | | | | | |
| 1 | ∞ (Dummy Place) | 0.00 | | | |
| 2 | Stop Surface | 0.00 | Decentration (1) | | |
| 3 | Aspheric Surface [1] | 0.00 | Decentration (2) | 1.5254 | 56.2 |
| 4 | FFS[1] | 0.00 | Decentration (3) | 1.5254 | 56.2 |
| 5 | Aspheric Surface [1] | 0.00 | Decentration (2) | 1.5254 | 56.2 |
| 6 | FFS[1] | 0.00 | Decentration (3) | 1.5254 | 56.2 |
| 7 | FFS[2] | 0.00 | Decentration (4) | | |
| 8 | ∞ | 0.00 | Decentration (5) | | |
| Image Plane | ∞ | 0.00 | | | |

Aspheric Surface [1]

| | | | |
|---|---|---|---|
| Radius of Curvature | −102.47 | | |
| k | 0.0000e+000 | | |
| a | 1.0851e−005 | b | −2.7562e−008 |

FFS[1]

| | | | | | |
|---|---|---|---|---|---|
| C4 | −7.8476e−003 | C6 | −9.2499e−005 | C8 | −2.3026e−004 |
| C10 | −6.3167e−004 | C11 | 6.0763e−006 | C13 | −4.0590e−006 |
| C15 | 2.4348e−005 | C17 | 3.8980e−007 | C19 | 7.8045e−007 |
| C21 | −3.7845e−007 | | | | |

FFS[2]

| | | | | | |
|---|---|---|---|---|---|
| C4 | 7.2049e−002 | C6 | −7.9408e−002 | C8 | 8.8428e−003 |
| C10 | 1.0410e−002 | C11 | −1.9082e−004 | C13 | 1.9511e−003 |
| C15 | 3.4916e−004 | | | | |

Decentration [1]

| | | | | | |
|---|---|---|---|---|---|
| X | 0.00 | Y | 0.00 | Z | 28.30 |
| α | 0.00 | β | 0.00 | γ | 0.00 |

Decentration [2]

| | | | | | |
|---|---|---|---|---|---|
| X | 0.00 | Y | 5.79 | Z | 28.34 |
| α | 0.56 | β | 0.00 | γ | 0.00 |

Decentration [3]

| | | | | | |
|---|---|---|---|---|---|
| X | 0.00 | Y | −7.51 | Z | 31.34 |
| α | −26.48 | β | 0.00 | γ | 0.00 |

Decentration [4]

| | | | | | |
|---|---|---|---|---|---|
| X | 0.00 | Y | 22.97 | Z | 36.49 |
| α | −32.55 | β | 0.00 | γ | 0.00 |

Decentration [5]

| | | | | | |
|---|---|---|---|---|---|
| X | 0.00 | Y | 24.17 | Z | 32.69 |
| α | −40.00 | β | 0.00 | γ | 0.00 |

The X- and Y-direction angles of view are 15° and 11.3°, and the entrance pupil diameter is 4 mm.

The values of the constituting elements and Conditions (1) and (2) in Examples 1, 2 and 3 are set out in Table 1 given below.

TABLE 1

| | Example 1 | Example 2 | Example 3 |
|---|---|---|---|
| Tn | 6.6 | 6.7 | 5.2 |
| Tc | 8.1 | 8.1 | 6.3 |
| Ts | 4.4 | 4.8 | 6.4 |
| Tn/Tc | 0.815 | 0.827 | 0.827 |
| Ts/Tc | 0.543 | 0.590 | 1.029 |

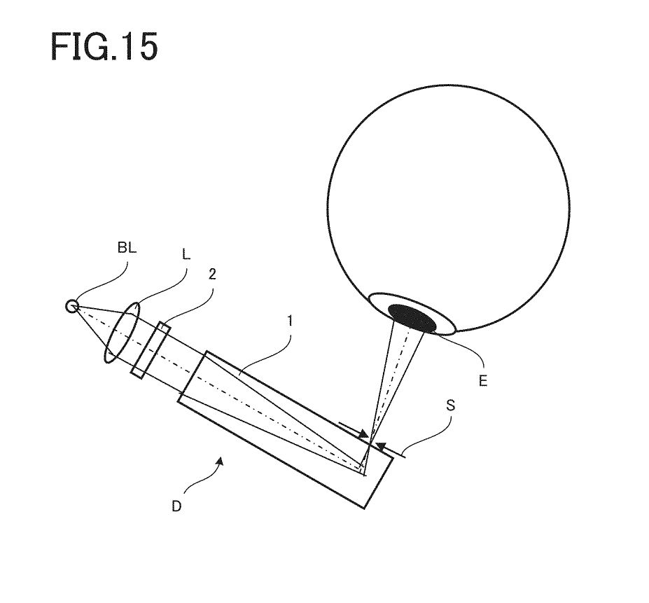

FIG. 15 is illustrative of the fundamental arrangement of the image display apparatus that incorporates the prism optical system.

By use of the prism optical system 1 and image display device 2b, the image display apparatus D as described herein can be reduced in terms of both size and weight, and allows the wearer to look objectively normal.

In the image display apparatus D as described here, a liquid crystal display device is used as the image display device 2b for which a backlight BL must be used as a light source. In the embodiment here, a lighting lens L is interposed between the backlight BL and the image display device 2b.

In the thus set-up image display apparatus D, image light exiting out of the image display device 2 is bent by the prism optical system 1 having a positive power toward the eyeballs, and allows the viewer to view images as virtual ones too.

If the vicinity of an exit portion is allowed to function just like an aperture stop S, it is then possible to view images even when the prism itself is slimmed down.

Further, when the image display device 2b is of the liquid crystal type, the backlight BL is required, so it is desired in view of lighting efficiency that an image from the light source be positioned in the vicinity of an exit window.

Preferably, a center chief ray exiting out of the image display apparatus D is positioned in such a way as to lie somewhat outside the frontal direction with respect to the eyeballs. This will prevent the display screen or reflecting portion from blocking off the front of the field of view, and make the optical path shorter thereby rendering the prism optical system 1 more compact.

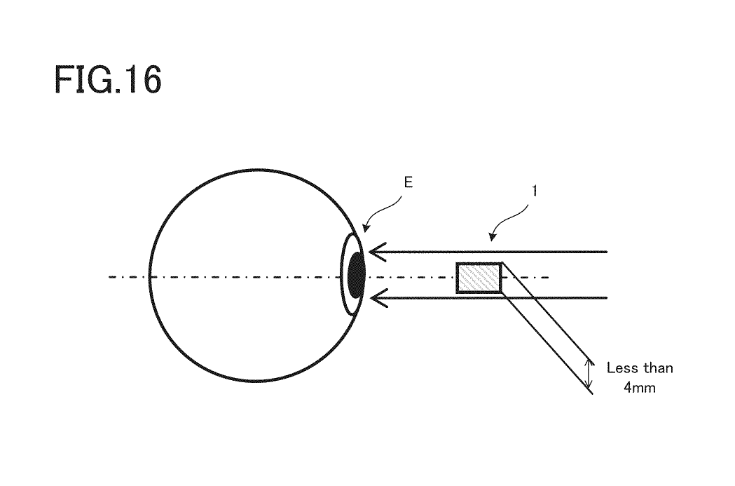

FIG. 16 is a side view of the image display apparatus that incorporates the prism optical system 1.

As shown in FIG. 16, the width of a portion in the vertical direction of the prism optical system 1 in opposition to the pupil E of the viewer is set to less than 4 mm that is a human's average pupil diameter. It is then possible to cast scenes in the rear of the prism optical system 1 onto the pupil E of the viewer from above and below the prism optical system 1, that is, to obtain the see-through effect.

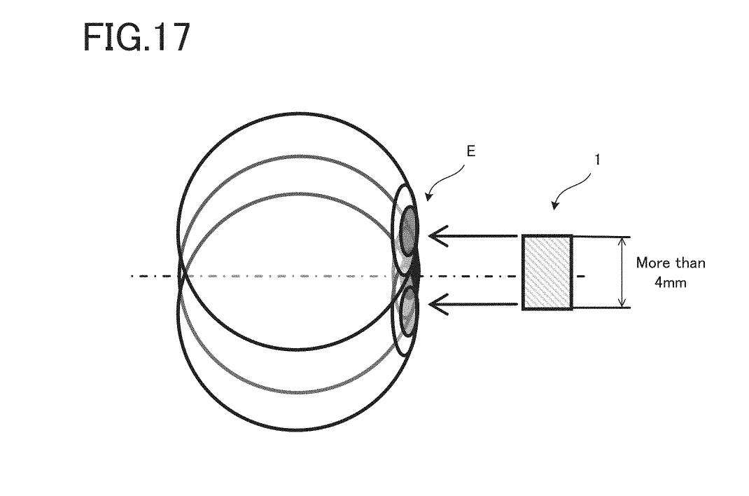

FIG. 17 is a side view of another example of the image display apparatus that incorporates the prism optical system.

As shown in FIG. 17, the width of a portion in the vertical direction of the prism optical system 1 in opposition to the pupil E of the viewer is set to greater than 4 mm. It is then possible to make use of an increased height thereby rendering tolerance for vertical shifting higher.

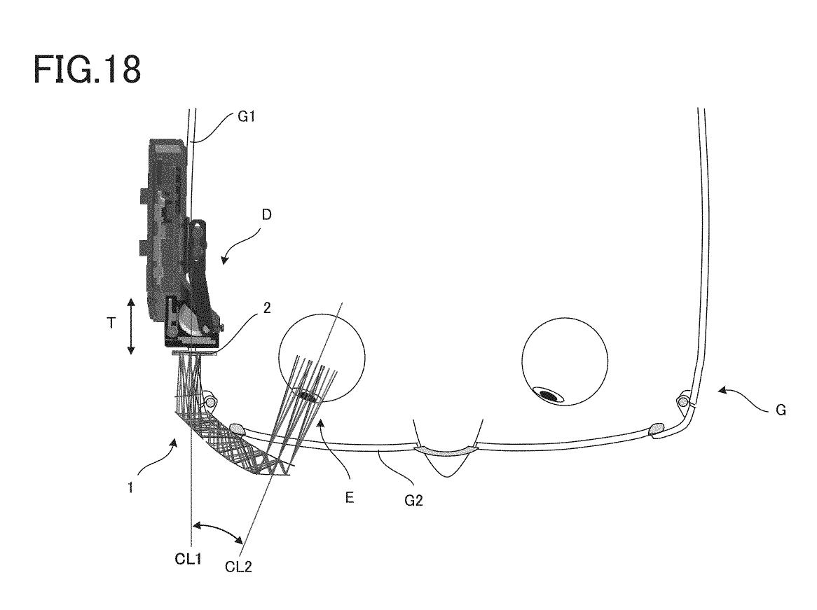

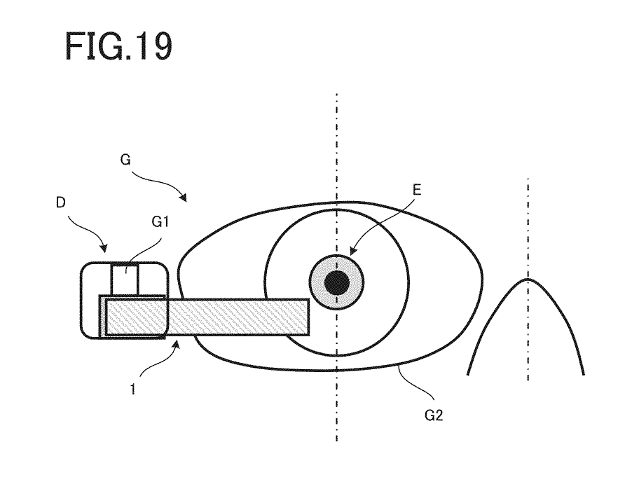

FIG. 18 is illustrative of a head-mounted type image display apparatus D that incorporates the prism optical system 1, and FIG. 19 is a front view of the head-mounted type image display apparatus D that incorporates the prism optical system 1.

The image display apparatus D here makes it possible to view an external world and electronic images at the same time without disturbing the field of view for external worlds (the see-through function) while it can be reduced in terms of both size and weight.

As shown in FIG. 18, the prism optical system 1 may be mounted on eyeglasses G. Image light exiting out of the frontally oriented image display device 2b is directed through the prism optical system 1 toward the pupil. The prism optical system 1 has a positive power enough to enlarge an image from the image display device 2b so that the wearer can view it as a virtual image. If the image display device 2b is moved back and forth along the direction (indicated by an arrow T) substantially along the temple portion G1, it is then possible to adjust it in conformity with the diopter of the viewer. Note here that the angle between the first center chief ray CL1 exiting out of the center of the image display device 2b and the second center chief ray CL2 exiting out of the prism and arriving at the center of the viewer's pupil is preferably 0° to 40°.

In the image display apparatus D of FIG. 1 as viewed from the front, the prism optical system 1 is located in opposition to the viewer's pupil E, as shown in FIG. 19, so that an enlarged virtual image can be presented to the viewer.

The prism optical system 1 here may be used with the imaging device 2a instead of the image display device 2b, so it is possible to provide an imaging apparatus C that can be reduced in terms of size, weight and cost.

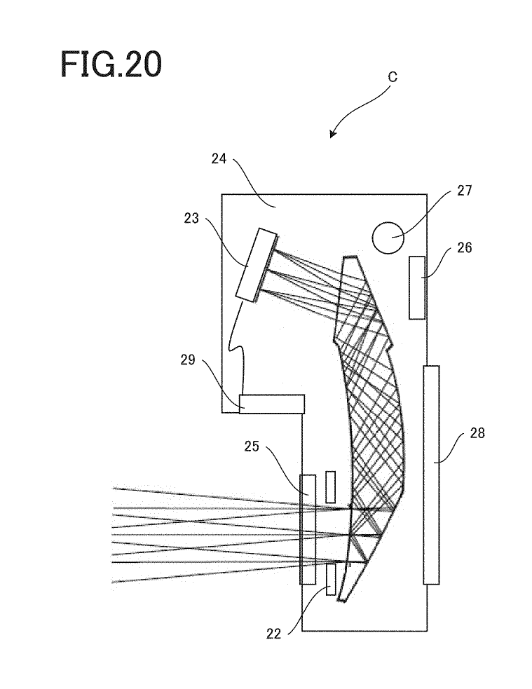

FIG. 20 is illustrative in conception of the imaging system C or digital camera to which the prism optical system 1 here is applied.

When the prism optical system 1 is applied to the imaging apparatus C, the exit pupil of the image display apparatus acts as an entrance pupil, near which an aperture stop 22 is provided. The aperture of this stop is expanded or contracted for brightness adjustment. Further, an imaging device 23 is located instead of the display device.

A camera body 24 is provided with an entrance window 25 adapted to take in light and prevent contamination of its interior, a switch 26, a shutter 27, and a back panel 28 adapted to check up operation and imaging. As the shutter 27 is pressed down with the switch 26 held on, it causes a shutter (not shown) annexed to the imaging device 23 to be put in actuation to take still images for a time set at shutter speed in an imaging device (CCD) 23 and store image data in an image recording memory 29. Moving images may be taken as is the case with still images, but with the shutter released open, they are captured in the imaging device 23 and accumulated in the memory.

### REFERENCE SIGNS LIST

1: Prism Optical System
2a: Imaging Device
2b: Image Display Device
C: Imaging Apparatus
D: Image Display Apparatus

1. A prism optical system comprising:
an optical element that includes at least three optical surfaces, each having an optical action, in which after subjected to at least three internal reflections, incident light exits out for formation of images, wherein
the optical element includes an entrance-side reflecting surface having reflection on the most entrance-side of the optical element on an optical path, an exit-side reflecting surface having reflection on the most exit side of the optical element on the optical path, and an intermediate reflecting surface having reflection between the entrance-side reflecting surface and the exit-side reflecting surface on the optical path,
given that a Z-axis positive direction is defined by a direction along a direction of travel of a center chief ray that passes from an origin through the center of an entrance pupil and is perpendicular to a surface that forms the entrance pupil, a Y-Z plane is defined by a plane including the Z-axis and the center of an image plane, and a Y-axis positive direction comes close to a direction from the origin toward the center of the image plane, and an X-axis positive direction is defined by a direction that forms a right-handed orthogonal coordinate system with the Y-axis and the Z-axis,
a thickness of an intermediate area including the intermediate reflecting surface in the X-Z plane is greater than a thickness of an entrance-side area including the entrance-side reflecting surface or a thickness of an exit-side area including the exit-side reflecting surface, and
the following condition (1) is satisfied:
0.5<Tn/Tc<1.0 (1)
where Tn is a thickness of the entrance-side area including the entrance-side reflecting surface, and Tc is a thickness of the intermediate area including the intermediate reflecting surface.

2. A prism optical system comprising:
an optical element that includes at least three optical surfaces, each having an optical action, in which after subjected to at least three internal reflections, incident light exits out for formation of images, wherein
the optical element includes an entrance-side reflecting surface having reflection on the most entrance side of the optical element on an optical path, an exit-side reflecting surface having reflection on the most exit side of the optical element on the optical path, and an intermediate reflecting surface having reflection between the entrance-side reflecting surface and the exit-side reflecting surface on the optical path,
given that a Z-axis positive direction is defined by a direction along a direction of travel of a center chief ray that passes from an origin through the center of an entrance pupil and is perpendicular to a surface that forms the entrance pupil, a Y-Z plane is defined by a plane including the Z-axis and the center of an image plane, and a Y-axis positive direction comes close to a direction from the origin toward the center of the image plane, and an X-axis positive direction is defined by a direction that forms a right-handed orthogonal coordinate system with the Y-axis and the Z-axis,
a thickness of an intermediate area including the intermediate reflecting surface in the X-Z plane is greater than a thickness of an entrance-side area including the entrance-side reflecting surface or a thickness of an exit-side area including the exit-side reflecting surface, and
the following condition (2) is satisfied:
0.3<Ts/Tc<1.0 (2)
where Ts is the thickness of the exit-side area including the exit-side reflecting surface, and Tc is a thickness of the intermediate area including the intermediate reflecting surface.

3. The prism optical system according to claim 1,
wherein the optical surfaces, each having an optical action, are mutually decentered, and at least two out of the at least three optical surfaces are each defined by a rotationally asymmetric surface.

4. The prism optical system according to claim 1,
wherein the entrance-side reflecting surface and the intermediate reflecting surface that includes at least one surface, or the exit-side reflecting surface and the intermediate reflecting surface that includes at least one surface are the same surface.

5. The prism optical system according to claim 1,
wherein the entrance-side reflecting surface, the exit-side reflecting surface and the intermediate reflecting surface that includes at least one surface are the same surface.

6. The prism optical system according to claim 1,
wherein the most entrance-side transmitting surface on the optical path has a negative power.

7. The prism optical system according to claim 2,
which satisfies the following condition (1):
0.5<Tn/Tc<1.0 (1)
where Tn is a thickness of the entrance-side area including the entrance-side reflecting surface, and Tc is a thickness of the intermediate area including the intermediate reflecting surface.

8. A prism optical system-incorporated image display apparatus comprising:
a prism optical system according to claim 1 including the optical element, and
an image display device located in the most exit-side transmitting surface of the optical element on the optical path, wherein:
a viewer's eye is located in opposition to the most entrance-side transmitting surface of the optical element on the optical path to present an enlarged virtual image to the viewer.

9. A prism optical system-incorporated imaging apparatus comprising:
a prism optical system according to claim 1 including the optical element,
an imaging device located in opposition to the most exit-side transmitting surface of the optical element on the optical path, and
an aperture stop located in the vicinity of the most entrance-side transmitting surface of the optical element on the optical path, whereby external-world images are taken.
